(19) United States
(12) Patent Application Publication
(10) Pub. No.: US 2004/0240048 A1
(43) Pub. Date: Dec. 2, 2004

(54) Microscope tube

(76) Inventors: Peter Dietrich, Oberkochen (DE); Franz Muchel, Konigsbronn (DE); Axel Freerk, Gottingen (DE); Hans Brinkmann, Gottingen (DE)

Correspondence Address: Douglas J Christensen, Patterson Thuente Skaar & christensen, 4800 IDS Center, 80 South Eight Street, Minneapolis, MN, 55402, US

(21) Appl. No.: 10/481,653

(22) PCT Filed: May 13, 2002
(86) PCT No.: PCT/EP02/05252

(30) Foreign Application Priority Data
Jun. 26, 2001 (DE) 101 30 621.0

(51) Int. Cl. G02B 21/00

(52) U.S. Cl. 359/368; 359/431

(57) ABSTRACT

A microscope tube comprises a housing (1) having a lower housing part (3) and an upper housing part (2), input optics (9) mounted on the lower housing part (3), which are provided for coupling to an infinite optical path of a microscope, a tube lens (12) mounted in the upper housing part (2), which is arranged on a common optical axis (OA1) with the input optics (9) and combines ray pencils supplied by the input optics (9) in an intermediate image, so that a finite optical path is formed between the tube lens (12) and the intermediate image, and a prism unit (13) mounted in the upper housing part (2) and arranged following the tube lens (12), said prism unit (13) deflecting the further optical path (OA2) by a solid angle of between 65° and 75° and being arranged in the finite optical path such that the intermediate image is viewable without further intermediate imaging by binocular optics (4) mountable on the upper housing part (2), said upper housing part (2) and said lower housing part (3) being mutually displaceable along the optical axis (OA1).

The invention relates to a microscope tube which is adapted for coupling to an infinite optical path of a microscope and comprises a tube lens generating an intermediate image which can be viewed through binocular optics.

Such microscope tubes are known. For example, DE 195 138 70 A1 describes a microscope tube comprising a tube lens, which transmits the image to an intermediate image plane of an eyepiece, and a corresponding deflecting device, so as to allow convenient viewing of the image through a binocular eyepiece. Said microscope tube is provided such that the angle by which the optical path is deflected is adjustable over a wide range of angles by means of a prism as well as a rotatable mirror. This allows adjustment of the viewing angle at which a viewer can look into the microscope tube.

However, such adjustment of the viewing angle automatically also changes the height of the tube eyepiece. In order to compensate this, an intermediate tube is provided in DE 198 285 48 A1 as a modular, separate part which can be arranged preceding the microscope tube carrying the binocular optics in the infinite optical path of a microscope. Said intermediate tube allows a height adjustment, so that both the angle and the height of the tube eyepiece can be adjusted within wide ranges, in combination with the tube having an adjustable viewing angle as known from DE 195 138 70 A1.

However, this concept of providing a tube eyepiece, which is as ergonomically favorable as possible, has the disadvantage that the microscope tube known from DE 195 138 70 A1 with adjustable viewing angle requires tube lenses having a relatively large intercept distance, because pivoting of the viewing eyepiece requires additional optical reflections, which inevitably increases the optical path length. Therefore, DE 195 138 70 A1 provides special tube lenses, although this is not always desired. If it is intended to omit such special tube lenses, an additional intermediate image may alternatively be realized, which, however, considerably increases the lateral dimensions of the microscope tube. This, in turn, may be an ergonomical disadvantage, because then, in some cases, the position of looking into the microscope tube may be a relatively great distance apart from the focus adjustment wheels of the microscope.

Therefore, it is an object of the invention to provide an ergonomically favorable microscope tube which is also useful for designs with tube lenses having a short intercept length.

This object is achieved by a microscope tube comprising input optics, which are provided for coupling to an infinite optical path of a microscope, a tube lens, which combines the ray bundles supplied by the distanced input optics in an intermediate image, so as to form a finite optical path between the tube lens and the intermediate image, and a prism unit arranged following the tube lens, which deflects a following optical path by a fixed angle of between 65° and 75° and is arranged in the finite optical path such that the intermediate image is viewable without further intermediate imaging by binocular optics attachable to an upper housing part, with a height adjustment mechanism being provided by which the distance between the input optics and the tube lens is adjustable.

Thus, the invention leads away from the hitherto common approach of aiming to obtain a microscope tube which is as universally adjustable as possible. Instead, a fixed viewing angle of about 20° is now provided and combined with a height adjustment. Such a fixed viewing angle has been found to be more ergonomically favorable, because the wide adjustability of the viewing angle according to the prior art has regularly led to maladjustments by the users. In order to allow an optimal selection of the vertical position of the tube eyepiece, said fixed viewing angle is combined in the microscope tube with an integrated height adjustment mechanism. This combination according to the invention—selection of a fixed viewing angle near 20° and adjustment of the vertical position to the largest possible extent—allows to avoid a modular intermediate tube, which is a more complex solution in terms of construction and manufacture. By integrating the height adjustment mechanism into the microscope tube housing, manufacturing advantages are achieved, so that the microscope tube is now more inexpensive.

Moreover, due to the selection of the fixed viewing angle and the elimination of angle-adjustment mechanisms prone to maladjustment, the microscope tube is of a smaller, in particular shorter, construction. As a result, an unergonomically large distance between the tube eyepiece and the focus adjustment wheels of a microscope is avoided.

The prism unit provided in the housing effects the beam deflection required for the ergonomically favorable viewing angle. In this connection, an angle of deflection, which is defined as the complement between the original optical axis and the optical axis present after deflection, of between 65° and 75° has turned out to lead to a particularly ergonomical viewing angle.

In a particularly convenient embodiment, the invention provides a microscope tube comprising a housing having an upper housing part and a lower housing part, in which the input optics are mounted, while the upper housing part carries the tube lens, which is arranged on one common optical axis with the input optics, wherein the upper housing part and the lower housing part are displaceable relative to one another along said optical axis. This two-part housing is of a particularly small construction and accommodates the height adjustment mechanism in an advantageous way.

The microscope tube according to the invention further has the advantage that different prism units may be used without substantial structural changes in the other parts.

Since in the biomedical application of microscopes use has hitherto been made mainly of microscope tubes with an inverted image orientation, this has had the effect of becoming a habit. Therefore, these users prefer microscope tubes with an inverted image orientation for such applications, a microscope tube comprising a prism unit which does not change the image orientation due to a double reflection is preferred. In this connection, a prism unit comprising first and second prisms distanced apart from one another by an air gap is particularly convenient, wherein the ray bundle entering the first prism is first totally reflected by its surface associated with the air gap and then reflected toward the second prism by an adjacent mirror surface. Such a prism structure has the advantage that the optical path length created thereby is extremely short. Therefore, it may advantageously be used also in tube lenses having a short intercept distance. If this marginal condition is not given, other prism arrangements employing an even number of reflections may also be used for deflection, of course.

For material testing applications, users often prefer upright, not laterally inverted images, so that the direction of displacement of a specimen corresponds to the movement of the image. Therefore, in such applications a prism unit is advantageous which combines a single reflection for vertical inversion with a corresponding device for lateral inversion. This is achieved in a particularly easy way by a prism unit causing an inversion of the image orientation and additionally comprising a pair of mirror-coated roof faces, which is known to result in a lateral inversion.

The height adjustment mechanism needs to allow variation of the distance between the tube lens and the input optics, which receives the ray bundles from the infinite optical path of the microscope. The optics following the tube lens are favorably arranged to remain at a fixed distance from the tube lens all the time. With afocal input optics, which are preferred for reasons of image correction, this is particularly easy to achieve by a design of the housing in which a lower housing part is telescopically slidable into an upper housing part, if the lower housing part carries the input optics and the upper housing part carries the tube lens including the subsequent optics.

Known guiding rods may be used to guide the unit carrying the input optics and the unit carrying the tube lens including the subsequent optics. A particularly precise guiding is achieved by means of a ballscrew guide, wherein, preferably, a slide carriage runs in guide rails. Such a ballscrew guide further has the advantage that inexpensive standard parts may be used.

The drive of the height adjustment mechanism is subject only to minor requirements, as long as the mutual position is guaranteed by said guide. Low precision will then only affect the convenience of vertical adjustment, but not the optical properties of the microscope tube. A particularly simple mechanism which, at the same time, exhibits relatively high precision of adjustment, is achieved by a rack and pinion drive. The latter may be provided such that the pinion is rotatably mounted on the upper housing part and engages with a rack mounted on the lower housing part. Of course, the positions of the pinion and of the rack may also be inverted.

In general, it has turned out to be favorable for a microscope tube comprising a height adjustment mechanism, a vertical position cannot be inadvertently changed after adjustment. For this purpose, generally any suitable fixing mechanism counteracting a change in the distance between the input optics and the tube lens is useful; for example, corresponding locks are conceivable, which block the adjusting mechanism, such as pawls or the like. An adjusting mechanism which need not be blocked separately, but which always requires a certain force to be overcome for adjustment, is particularly convenient. In this connection, a particularly simple embodiment is a sliding coupling which inhibits the height adjustment mechanism of the input optics and of the tube lens.

In an adjustment mechanism driven by a rotary shaft, such a sliding coupling advantageously provided between the shaft and a housing part in which the shaft is supported. In an embodiment which is particularly favorable to manufacture, a shaft is provided, which is rotatably supported in a housing part and whose rotation drives the mutual displacement of the input optics and of the tube lens, said shaft being fitted with a sliding disk, which is clamped onto a sliding lining attached to the housing part, so as to form a sliding coupling which inhibits rotation of the shaft. This design requires few moving parts as well as only few friction linings. Particularly advantageously, said friction linings may comprise teflon, because this is particularly wear-resistant.

A fixing mechanism, in particular embodied as a sliding coupling, has the advantage that a selected vertical position is maintained largely independently of the weight of the microscope tube or of the weight applied on the microscope tube by a camera, for example.

In a microscope having a vertically oriented optical axis, in most cases, the tube lens including the subsequent optics, in particular the eyepiece, is moved upward in order to increase the distance between the input optics and the tube lens. Increasing the distance then requires a different force than reducing the distance between the input optics and the tube lens. In order to compensate this ergonomically disadvantageous effect, it is convenient to clamp a spring unit between the support holding the input optics, e.g. the lower housing part, and the support holding the tube lens with the subsequent optics, e.g. the upper housing part, said spring unit providing a largely forceless adjustment of the distance between the input optics and the tube lens in both directions.

The angle by which the prism unit deflects the optical path may be freely selected within the range of between 65° and 75° according to the invention. An angle of deflection near or equal to 70° has turned out to be particularly ergonomical, so that a viewing angle of near or equal to 20° is achieved, when the optical axis extends vertically.

In microscopes, cameras are often attached in order to record images. In doing so, it is particularly convenient if the camera is then positioned in the intermediate image plane of the tube lens. This could be effected principally by mounting the camera on the eyepiece front end. However, it has proven more advantageous if the prism unit can be moved out of the optical path and a camera connection is provided, by means of which the intermediate image is recordable by a camera attached to the camera connection, when the prism unit is moved out, so that the intermediate image is imaged directly into the camera. The eyepiece can then be maintained in position with the camera mounted and need not be removed.

The invention will be explained in more detail below, by way of example and with reference to the Figures, wherein:

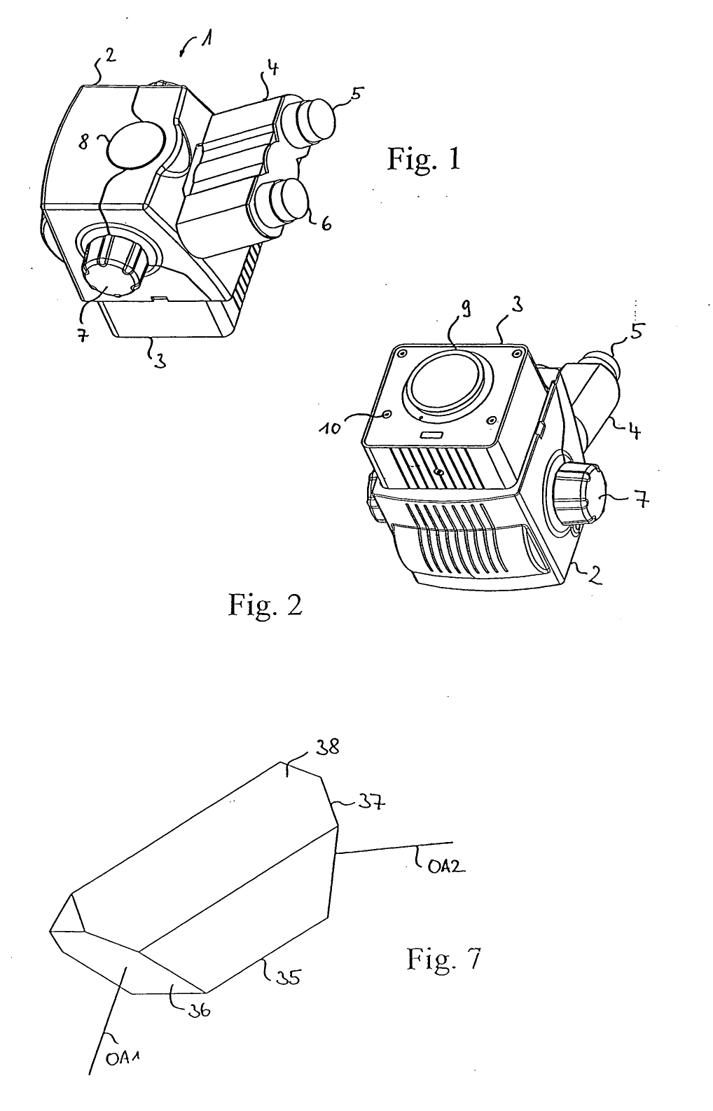

FIG. 1 shows a perspective top view of a microscope tube,

FIG. 2 shows a perspective bottom view of a microscope tube,

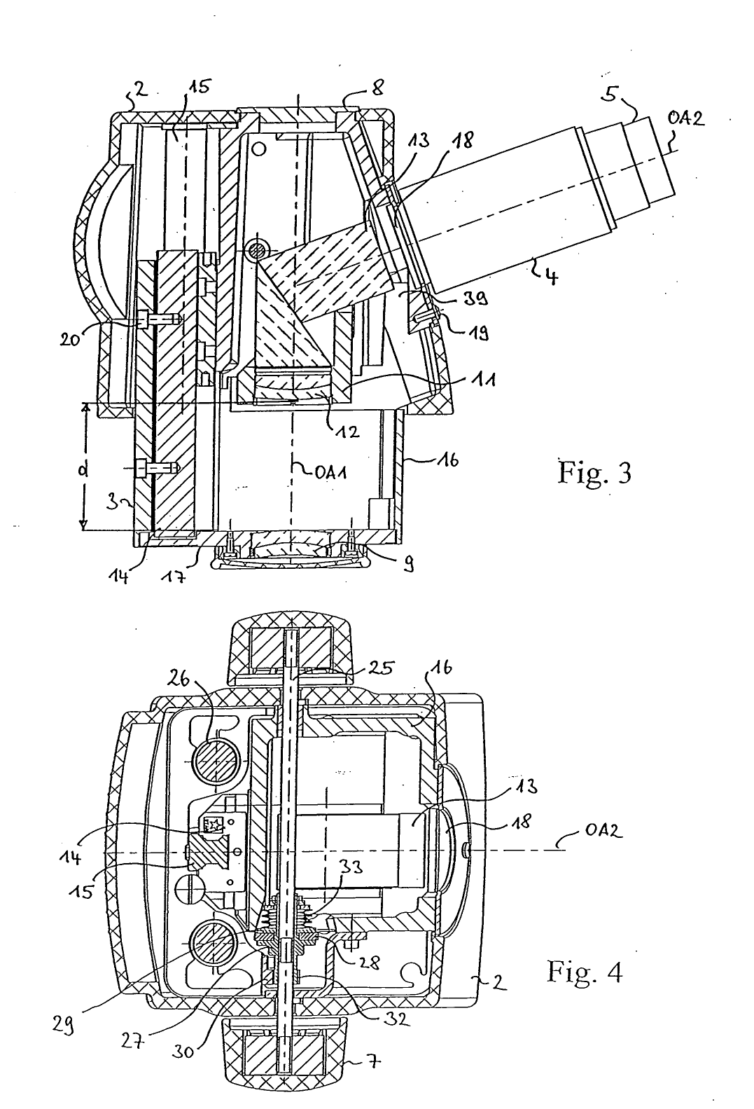

FIG. 3 shows a longitudinal section through the microscope tube along the optical axis,

FIG. 4 shows a cross-section through the microscope tube in the plane of a height adjustment mechanism,

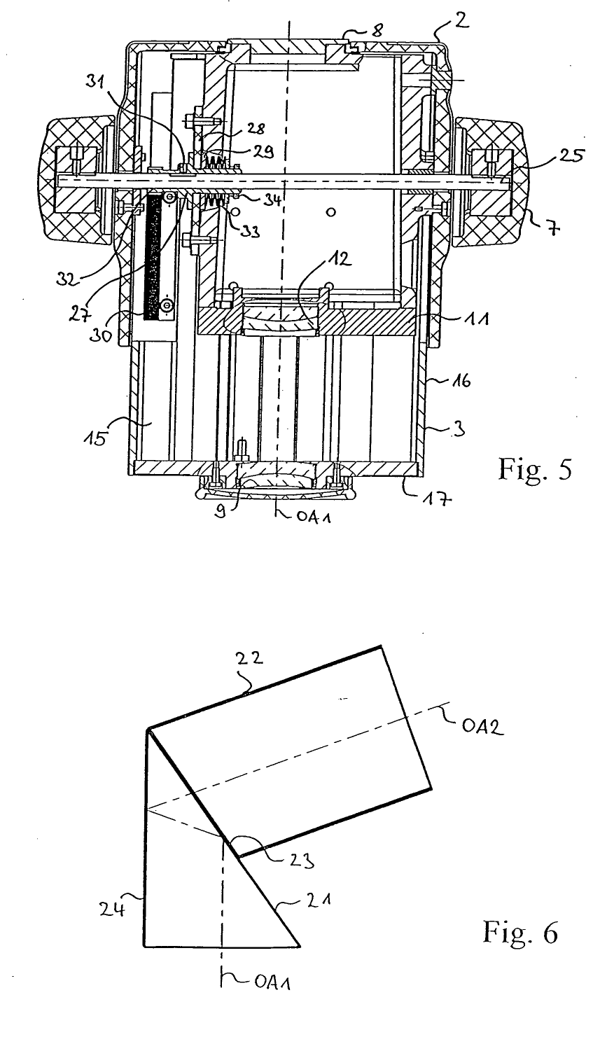

FIG. 5 shows a further longitudinal section of the microscope tube in the plane of the optical axis and of the adjustment mechanism,

FIG. 6 is a schematic view showing a prism unit of the microscope tube, and

FIG. 7 shows an optional embodiment of the prism unit.

FIG. 1 is a perspective view showing a microscope tube intended for mounting on a microscope stand. The microscope tube comprises a two-part housing having an upper housing part 2 and a lower housing part 3. A binocular eyepiece which, as will be explained in more detail hereinafter, allows a viewing angle of 20° when the housing 1 of the microscope tube is mounted on a microscope having a vertically extending axis is attached to the upper housing part 3. Two eyepiece inserts 5 and 6, whose distance is adaptable to the distance between the user's eyes, are inserted into the binocular part 4.

The housing 1 of the microscope tube is adjustable such that the lower housing part 3 is telescopically slidable into the upper housing part 2. This telescope movement is actuated via a height adjustment wheel 7. On the upper surface of the housing 1, there is further visible a cover 8 provided for a camera connection which will be explained later.

FIG. 2 shows the microscope tube in a perspective bottom view. Input optics 9 by means of which radiation from the infinite optical path may be coupled into the microscope are provided in the bottom of the lower housing part 3. For mounting on the microscope stand, the lower housing part 3 has threaded holes 10 in its bottom, by which the housing 1 can be screwed onto the microscope stand.

FIG. 3 shows a sectional view of the internal structure of the microscope tube. The input optics 9, which are arranged in the bottom 17 of the lower housing part 3 being provided as a sliding part, are positioned on the optical axis OA1 of the microscope, when mounting the microscope tube on a microscope stand. The input optics 9, which are made up of two lenses in the present example, are afocal, i.e. they extend the telecentric region within the infinite optical path of the microscope.

A tube lens 12 is arranged following the input optics 9, said tube lens 12 being mounted in a prism support holding a prism unit 13, which is arranged following the tube lens 12. The tube lens 12 turns the ray bundles guided by the input optics 9 in the infinite optical path into an intermediate image which then becomes visible through the binocular part 4. In doing so, the prism unit 13 effects deflection of the optical path by an angle of 70°. The structure of the prism unit 13 will be explained in more detail hereinafter with reference to FIG. 6.

The rays deflected by the prism unit 13 are incident on the binocular part 4 through a binocular opening 18 provided in a binocular flange 19, which is mounted on the upper housing part 2 by screws. From there, said rays in the form of the intermediate image can be viewed with the help of the eyepiece inserts 5 and 6.

A slide carriage 14 of a ballscrew guide is mounted on a wall of the lower housing part 3 via screws 20, said slide carriage 14 running in a guide rail 15 mounted on the upper housing part 2. The ballscrew guide effects precise vertical guiding of the lower housing part 3 relative to the upper housing part 2 along the optical axis OA1.

In the maximally extended condition, i.e. when the slide carriage 14 contacts a stop (not shown in the Figures), the height d, i.e. the distance, between the input optics 9 and the tube lens 12 is at a maximum. In order to reduce the height d, the lower housing part 3 slides into the upper housing part 2, which has the effect that, when the lower housing part 3 is mounted on a microscope stand, the viewing height at which a user of the microscope looks into the eyepiece inserts 5 and 6 decreases.

When sliding the lower housing part 3 into the upper housing part 2, the wall of the lower housing part extends into the upper housing part. This is exemplified by the skirt-like wall 16. In order to allow the lower housing part 3 to be slid into the upper housing part as far as possible, until the input optics 9 are at the minimum admissible distance from the tube lens 12, the rear surface of the binocular flange 19 is provided with a gap 39 which is located between the prism unit 13 and the binocular flange 19 and in which the wall 16 may be accommodated. The maximum depth of insertion of the lower housing part 3 into the upper housing part 2 is, thus, determined by the distance between the lower edge of the upper housing part 2 and the upper edge of the gap 39. Since said distance is limited by the length of the prism unit 13, which may not be freely selected for optical reasons, the gap 39 is, therefore, provided for a maximum adjustment range such that the wall 16 moves past the prism unit 13, but without coming into the optical path to the binocular part 4, i.e. overlapping with the binocular opening 18.

When the lower housing part 3 is securely attached to a microscope stand, the upper housing part 2, including the eyepiece part 4 attached to it, is raised through said height adjustment, if the height d is increased. As drive, the height adjustment wheel 7 is provided, which drives a shaft 25. FIGS. 4 and 5 show different sectional views through the microscope tube 1, each in the plane of said shaft 25.

The shaft 25 is supported within the upper housing part 1 and carries a sleeve element 27 attached in a manner locked against rotation via a grub screw 31. A gearwheel 32, which can be rotated by the height adjustment wheel 7, is fitted on the sleeve element 27. The gearwheel 32 engages a rack 30 attached to the lower housing part 3, so that the rack 30 and the gearwheel 32 form a rack and pinion drive for changing the height d. In order to make said variation as effortless as possible, spring units 26 are biased between the upper housing part 2 and the lower housing part 3, which compensate the inherent weight of the upper housing part 2 as well as of the binocular part 4 attached thereto. The tension of each spring unit 26 is preferably adjustable in a manner suitable to enable adaptations to binocular parts 4 differing in weight. In order to produce equal conditions for upward and downward movements, the spring units have a very flat spring characteristic curve, which is selected precisely such that it compensates the weight of the moving parts, i.e. of the upper housing part 2 including the parts attached thereto.

However, because a camera may also be optionally attached to the microscope tube 1 instead of the cover—which then increases the weight to be supported by the spring units—a sliding coupling unit is additionally provided. The latter comprises a teflon plate 28 fitted to a wall of the upper housing part 2 in the embodiment example. A friction disk 29, which may also be made of teflon, is pressed onto this teflon plate by a cup spring 33 arranged on the shaft 25. For this purpose, the cup spring 33 is supported on a support plate 34 mounted on the shaft 25 and has an adjustable bias making its supporting force adjustable. Optionally, a clamping screw may be employed in addition, allowing to support weights of up to 5 kg for a conventionally designed cup spring.

The microscope tube 1 is designed such that different prism units may be employed. In a first variant, the prism unit shown in FIG. 6 is provided, which comprises a two-part group of prisms. The group comprises a Bauernfeind prism 21, which acts as deflection prism. Its vertically oriented prism surface comprises a mirror surface 24. An additional prism 22 is arranged above an air gap 23 of few 1/10 mm, separated from the Bauernfeind prism 21, and has the effect that the optical path passing obliquely through the air gap 23 exits the prism unit at a surface which is perpendicular to the optical axis OA2. The length of the additional prism 23 allows the optical path to be shortened, because light paths traveled in glass result in a shorter optical path length than the same distance in an air path. The fact that the air gap 23 is obliquely traversed by the optical axis OA2 and, thus, by the optical path, is not a disadvantage for image quality. As there is a total of two reflections in the Bauernfeind prism 21, at the air gap 23 and at the mirror surface 24 , the original image orientation remains unchanged. Further, a special glass is employed, which enables total reflection due to a suitable refractive index and, at the same time, ensures that the tube lens intercept length is maintained.

Optionally, with respect to the prism group of FIG. 6, use may also be made of the prism shown schematically in the perspective view of FIG. 7, said prism causing an image inversion, i.e. a reversal of the image orientation with respect to its vertical and lateral orientation. This prism unit is provided as a one-part roof face prism 38 comprising an input surface 36 perpendicular to the optical axis OA1 and an output surface 37 perpendicular to the optical axis OA2. Two mirror-coated roof faces 38 cause the corresponding beam deflection. Since in the roof face prism 35 the optical path is reflected only once, this results in a vertical inversion. The two roof faces 38 simultaneously result in a lateral reversal.

Both prisms deflect the optical path by about 70°, so that the optical axis OA2 extends at an angle of about 20° to horizontal, when the optical axis OA1 is vertically oriented.

The prism units 13 of FIGS. 6 and 7 are designed such that they may be employed as exchangeable modules. Thus, as desired by the user, the same microscope tube may show either a laterally and vertically correct image or a correspondingly inverted image in the binocular part 4. Extensive optical or mechanical changes are not required.

In order to mount a camera instead of the cover 8, a mounting device (not shown) is provided; further, the prism unit 13 is fitted on a carriage (not shown), so as to be able to move it out of the optical path, when an image is to be recorded by the camera.

1. A microscope tube comprising:
input optics, adapted for coupling to an infinite optical path of a microscope,
a tube lens distanced from the input optics, which combines ray bundles supplied by the input optics in an intermediate image, so that a finite optical path is formed between the tube lens and the intermediate image, and
a prism unit arranged following the tube lens, said prism unit deflecting a following optical path by a fixed angle of between about 65° and about 75° and being arranged in the finite optical path such that the intermediate image is viewable without further intermediate imaging by binocular optics mountable on an upper housing part of the tube, wherein and
an integrated height adjustment mechanism, by which the distance between the input optics and the tube lens is adjustable.

2. The microscope tube as claimed in claim 1, further comprising a housing, which has a lower housing part and the upper housing part, wherein the input optics are mounted on the lower housing part and the tube lens is mounted on the upper housing part, said tube lens and said input optics being located on one common optical axis and said upper housing part and said lower housing part being mutually displaceable along said optical axis.

3. The microscope tube as claimed in claim 1, wherein the prism unit comprises first and second prisms separated from one another by an air gap, wherein the first prism first totally reflects impinging ray bundles at its surface associated with the air gap and then reflects them toward the second prism at an adjacent, mirror-coated surface.

4. The microscope tube as claimed in claim 1, wherein the prism unit inverts the image orientation, by a pair of mirror-coated roof faces.

5. The microscope tube as claimed in claim 2, wherein the lower housing part is telescopically slidable into the upper housing part.

6. The microscope tube as claimed in claim 1, wherein the height adjustment mechanism comprises a ball screw guide for guiding the input optics and the tube lens.

7. The microscope tube as claimed in claim 1, wherein the height adjustment mechanism comprises a rack and pinion drive.

8. The microscope tube as claimed in claim 1, whose optical path is deflected by an angle of about 70°, so that a viewing angle of about 20° is achieved, if the optical axis of the tube lens extends vertically.

9. The microscope tube as claimed in claim 1, wherein the prism unit is movable out of the optical path and further comprising a camera connector, by which the intermediate image is recordable by a camera mountable on the camera connector, when the prism unit has been moved out of the optical path.

10. The microscope tube as claimed in claim 1, wherein the height adjustment mechanism comprises a sliding coupling.

11. The microscope tube as claimed in claim 2 further comprising a shaft, which is rotatably supported in the upper housing part and whose rotation drives the mutual displacement of the upper housing part and the lower housing part, said shaft being fitted, in a manner blocked against rotation, with a sliding disk, which is biased on a sliding lining mounted on the upper housing part, so as to form a sliding coupling which inhibits rotation of the shaft.

12. The microscope tube as claimed in claim 1, wherein the height adjustment mechanism comprises a biased spring unit.

13. A microscope tube comprising:
input optics adapted for coupling to an infinite optical path of a microscope;
a tube lens distanced from the input optics, the tube lens forming an intermediate image from light received from the input optics, at a finite distance from the tube lens along an optical path; and
a prism unit following the tube lens, said prism unit deflecting light by a fixed angle of between about 65° and about 75° and being arranged in the optical path such that the intermediate image is viewable without further intermediate imaging by binocular optics mountable on an upper housing part of the tube, and
an integrated height adjustment mechanism, to adjust the distance between the input optics and the tube lens.

14. The microscope tube as claimed in claim 13, further a comprising a housing including an upper portion and a lower portion, the lower portion supporting the input optics and the upper housing supporting the tube lens on a common optical axis and the two housings being movable relative to one another while maintaining the input optics and the tube lens on the common optical axis.

15. The microscope tube as claimed in claim 13, wherein the prism unit comprises a roof prism that inverts the intermediate image orientation.

16. The microscope tube as claimed in claim 13, in which the height adjustment mechanism comprises a ball screw guide.

17. The microscope tube as claimed in claim 13, in which the height adjustment mechanism comprises a rack and pinion.

18. The microscope tube as claimed in claim 13, in which the binocular optics have a second optical axis angled about twenty degrees above horizontal.
